(19) United States
(12) Patent Application Publication
(10) Pub. No.: US 2016/0207284 A1
(43) Pub. Date: Jul. 21, 2016

(54) FUNCTIONAL FILM AND PROCESS FOR MANUFACTURING FUNCTIONAL FILM

(71) Applicant: FUJIFILM Corporation, Tokyo (JP)

(72) Inventor: Eijiro IWASE, Ashigara-kami-gun (JP)

(73) Assignee: FUJIFILM Corporation, Tokyo (JP)

(21) Appl. No.: 15/083,941

(22) Filed: Mar. 29, 2016

Related U.S. Application Data
(63) Continuation of application No. PCT/JP2014/075378, filed on Sep. 25, 2014.

(30) Foreign Application Priority Data
Sep. 30, 2013 (JP) 2013-203267

(51) Int. Cl. B32B 7/12; B32B 37/14; B32B 37/12

(52) U.S. Cl. CPC B32B 7/12; B32B 37/12; B32B 37/14; B32B 2307/30

(57) ABSTRACT

A functional film has an organic layer and an inorganic layer which are alternately formed on a support and a transport support which is stuck to a rear surface of the support through an adhesive layer and has thermal characteristics different from thermal characteristics of the support, in which an adhesive force between the adhesive layer and the support is 5 N/25 mm to 50 N/25 mm, and an adhesive force between the adhesive layer and the transport support is 0.01 N/25 mm to 1 N/25 mm. In a state where a long laminate composed of the support, the adhesive layer, and the transport support is being transported in a longitudinal direction, the organic layer and the inorganic layer are alternately formed on a front surface of the support. As a result, there is provided a low-cost functional film in which the organic layer and the inorganic layer are alternately laminated and the inorganic layer or the like is not damaged and which stably demonstrates the intended performance. Furthermore, there is provided a process for manufacturing such a functional film.

### CROSS-REFERENCE TO RELATED APPLICATIONS

This application is a continuation of International Application No. PCT/JP2014/075378 filed on Sep. 25, 2014, which claims priority under 35 U.S.C. §119(a) to Japanese Patent Application No. 2013-203267 filed on Sep. 30, 2013. Each of the above applications is hereby expressly incorporated by reference, in its entirety, into the present application.

### BACKGROUND OF THE INVENTION

1. Field of the Invention

The present invention relates to a functional film having a laminated structure consisting of an organic layer and an inorganic layer and a process for manufacturing the functional film. Specifically, the present invention relates to a functional film in which an inorganic layer or the like is not damaged and a process for manufacturing a functional film that makes it possible to manufacture such a functional film at low cost.

2. Description of the Related Art

In various devices such as optical elements, display devices such as a liquid crystal display or an organic EL display, various semiconductor devices, and solar cells, a gas barrier film is used for sites or parts that require moisture-proof properties. Furthermore, a gas barrier film is used as a packing material for packing foods or electronic parts.

Generally, a gas barrier film is constituted with a plastic film such as a polyethylene terephthalate (PET) film as a support (substrate) and a gas barrier layer (gas barrier film) which is on the support and exhibits gas barrier properties. As the gas barrier layer used in the gas barrier film, for example, layers composed of various inorganic compounds such as silicon nitride, silicon oxide, and aluminum oxide are known.

As a constitution of such a gas barrier film from which higher gas barrier performance is obtained, an organic/inorganic laminated-type gas barrier film (hereinafter, also referred to as a laminated-type gas barrier film) having a laminated structure, in which an organic layer composed of an organic compound and an inorganic layer composed of an inorganic compound are alternately laminated on each other on a support, is known.

In the laminated-type gas barrier film, the inorganic layer mainly exhibits gas barrier properties. In the laminated-type gas barrier film, by forming the inorganic layer on the organic layer which becomes an underlayer, a surface on which the inorganic layer is formed is smoothed by the organic layer, and the inorganic layer is formed on the organic layer having excellent smoothness. In this way, a homogeneous inorganic layer without cracks, fissures, and the like is formed, and excellent gas bather performance is obtained. Furthermore, by repeatedly forming a plurality of laminated structures consisting of the organic layer and the inorganic layer, it is possible to obtain better gas barrier performance.

As a process for manufacturing such a laminated-type gas barrier film, so-called Roll to Roll (hereinafter, also referred to as RtoR) is known. RtoR is a manufacturing process in which a support is unwound from a support roll, which is formed by winding up a long support in the form of a roll, an organic layer or an inorganic layer is formed on the support in a state where the support is being transported in a longitudinal direction, and the support on which the organic layer or the inorganic layer is formed is wound up in the form of a roll.

If RtoR is used, the organic layer or the inorganic layer can be continuously formed in a state where the long support is being transported, and accordingly, a laminated-type gas barrier film can be manufactured with extremely high productivity.

As described above, in the laminated-type gas barrier film, the inorganic layer mainly exhibits gas barrier properties. Therefore, if the inorganic layer is damaged, the gas barrier performance greatly deteriorates.

Furthermore, in the laminated-type gas barrier film, the organic layer functions as an underlayer for appropriately forming the inorganic layer. Therefore, if the organic layer is damaged, the inorganic layer cannot be formed appropriately, and the gas barrier performance also greatly deteriorates.

Considering the optical characteristics, weight, cost, and the like, it is advantageous for the support in the laminated-type gas barrier film to be thin.

However, a thin support often has a problem such as being folded and bent while being transported by RtoR. If the support on which the organic layer or the inorganic layer is formed is folded and bent while being transported, the formed organic layer or the inorganic layer is damaged.

In addition, in RtoR, a pair of transport rollers, pass rollers (guide rollers), and the like inevitably come into contact with the organic layer or the inorganic layer in some cases. Due to the contact with such rollers, the organic layer or the inorganic layer is damaged in some cases.

As a solution to the aforementioned problems, it is known that at the time of manufacturing a laminated-type gas barrier film by using RtoR, noncontact transport is used by which the support is transported in a state where only the end thereof is pinched between so-called stepped rollers having a large diameter at the end.

However, in a case where the support is thin and thus easily folded and bent, it is much more difficult to appropriately transport such a support by the noncontact transport.

In order to solve the aforementioned problem, JP2011-149057A or JP2011-167967A discloses a process for manufacturing a gas barrier film (functional film) in which an organic layer or an inorganic layer is formed by RtoR by using a support including a transport support (laminate film) stuck to a rear surface thereof. Herein, the rear surface is a surface on which the organic layer or the inorganic layer is not formed.

According to the aforementioned process, by sticking the transport support to the rear surface of the support, the self-supporting property of the support can be secured, and even in a case where a thin support is used or in a case where the noncontact transport is used, it is possible to appropriately form the organic layer or the inorganic layer by RtoR without making the support folded and bent.

### SUMMARY OF THE INVENTION

In recent years, the use of the laminated-type gas barrier film in a top emission-type organic EL device, which is used in cellular phones, displays, and the like, has been considered.

In the laminated-type gas barrier film used for such purposes, it is necessary to use a support with excellent optical characteristics having a low retardation or high optical transmittance, such as a cycloolefin copolymer (COC) film. Furthermore, in view of the optical characteristics of the gas barrier film, it is preferable that the support is thin.

However, according to the investigation conducted by the inventor of the present invention, by RtoR using the aforementioned transport support, the laminated-type gas barrier film using the COC film or the like as a support cannot be appropriately manufactured at low cost.

That is, in manufacturing the laminated-type gas barrier film using the transport support, the transport support does not become a portion of the product and is ultimately peeled off and discarded. Therefore, as the transport support, an inexpensive PET film or the like is used.

In the laminated-type gas barrier film, for forming a general inorganic layer, a vapor-phase film forming method (vapor-phase deposition method) such as plasma CVD is used. Furthermore, for forming an organic layer, a coating method is used in which a coating material containing an organic material which will become the organic layer is used for coating and then subjected to drying and curing.

That is, in manufacturing the laminated-type gas barrier film, the support and the transport support are exposed to heat by the vapor-phase film forming method such as plasma CVD for forming the inorganic layer and exposed to heat at the time of drying the coating material for forming the organic layer. Furthermore, for forming the organic layer, heating is performed at the time of curing (cross-linking) the coating material in some cases.

A film having excellent optical characteristics, such as a COC film, and a PET film are completely different from each other in terms of thermal characteristics such as thermal expansion/thermal shrinkage or Tg. Therefore, in a process including heating, the two films are deformed in different ways.

In a case where films having different thermal characteristics are used as the support and the transport support in manufacturing the laminated-type gas barrier film by RtoR, due to the stress caused by transport, bending caused by the change in the transport path, and the like, the two films are deformed in different ways in the process including heating. As a result, the support is peeled off from the transport support or is wrinkled, and hence the inorganic layer is damaged.

If films composed of the same material are used as the support and the transport support, the aforementioned problems do not occur.

However, compared to a PET film or the like, a film having excellent optical characteristics, such as a COC film, is extremely expensive. Furthermore, as described above, the transport support is a material that is ultimately discarded. Accordingly, in a case where a film having excellent optical characteristics, such as a COC film, is used as the support, if a transport support composed of the same material as the support is used, the cost of the laminated-type gas barrier film extremely increases.

The present invention aims to solve the aforementioned problems of the related art, and objects thereof are to provide a low-cost organic/inorganic laminated-type functional film in which an organic layer and an inorganic layer are alternately formed and the inorganic layer is not damaged and which stably exhibits the intended performance and to provide a process for manufacturing the functional film.

In order to solve the aforementioned problems, the present invention provides a functional film including a support, an organic layer and an inorganic layer which are alternately formed on the support, an adhesive layer which is stuck to a surface of the support opposite to a surface of the support on which the organic layer and the inorganic layer are formed, and a transport support which is stuck to the adhesive layer and has thermal characteristics different from thermal characteristics of the support, in which an adhesive force between the adhesive layer and the support is 5 N/25 mm to 50 N/25 mm, and an adhesive force between the adhesive layer and the transport support is 0.01 N/25 mm to 1 N/25 mm.

It is preferable that in the functional film of the present invention, the adhesive layer has a thickness of 15 μm to 250 μm.

It is preferable that the adhesive layer has a total light transmittance of equal to or greater than 85% and has a retardation of equal to or less than 5 nm.

It is preferable that the support has a retardation of equal to or less than 300 nm.

It is preferable that the support has a glass transition temperature of equal to or higher than 130° C., a thermal shrinkage rate of equal to or less than 0.5%, and a thickness of 20 μm to 120 μm. Furthermore, it is preferable that the transport support has a glass transition temperature of equal to or higher than 60° C., a thermal shrinkage rate of greater than 0.5% and equal to or less than 2%, and a thickness of 12 μm to 100 μm.

In addition, the present invention provides a process for manufacturing a functional film, including preparing a long laminate by sticking a support to an adhesive layer at an adhesive force of 5 N/25 mm to 50 N/25 mm and sticking a transport support, which has thermal characteristics different from thermal characteristics of the support, to a surface of the adhesive layer opposite to the support at an adhesive force of 0.01 N/25 mm to 1 N/25 mm, and alternately forming an organic layer formed by a coating method and an inorganic layer formed by a vapor-phase film forming method on the surface of the support opposite to the adhesive layer while transporting the laminate in a longitudinal direction.

It is preferable that in the process for manufacturing a functional film of the present invention, the adhesive layer has a thickness of 15 μm to 250 μm.

It is preferable that the adhesive layer has a total light transmittance of equal to or greater than 85% and a retardation of equal to or less than 5 nm.

It is preferable that the support has a retardation of equal to or less than 300 nm.

It is preferable that the support has a glass transition temperature of equal to or higher than 130° C., a thermal shrinkage rate of equal to or less than 0.5%, and a thickness of 20 μm to 120 μm. Furthermore, it is preferable that the transport support has a glass transition temperature of equal to or higher than 60° C., a thermal shrinkage rate of greater than 0.5% and equal to or less than 2%, and a thickness of 12 μm to 100 μm.

According to the present invention, a functional film in which the inorganic layer or the like is not damaged and which has the intended performance can be manufactured at low cost by using an inexpensive transport support.

Furthermore, in the functional film of the present invention, the transport support can be peeled off with leaving the adhesive layer behind. Accordingly, the functional film of the present invention can be preferably used for purposes that require sticking of a gas barrier film afterwards, such as manufacturing of a polarizing plate to which a gas barrier film is stuck or sticking of a gas barrier film to organic EL display.

### BRIEF DESCRIPTION OF THE DRAWINGS

FIGS. 1A to 1C are views schematically showing an example of a functional film of the present invention.

FIG. 2A is a view schematically showing an example of an inorganic film forming device for performing a process for manufacturing a functional film of the present invention, and FIG. 2B is a view schematically showing an example of an organic film forming device for performing the process for manufacturing a functional film of the present invention.

### DESCRIPTION OF THE PREFERRED EMBODIMENTS

Hereinafter, a functional film of the present invention and a process for manufacturing a functional film of the present invention will be specifically described based on preferred examples illustrated in the attached drawings.

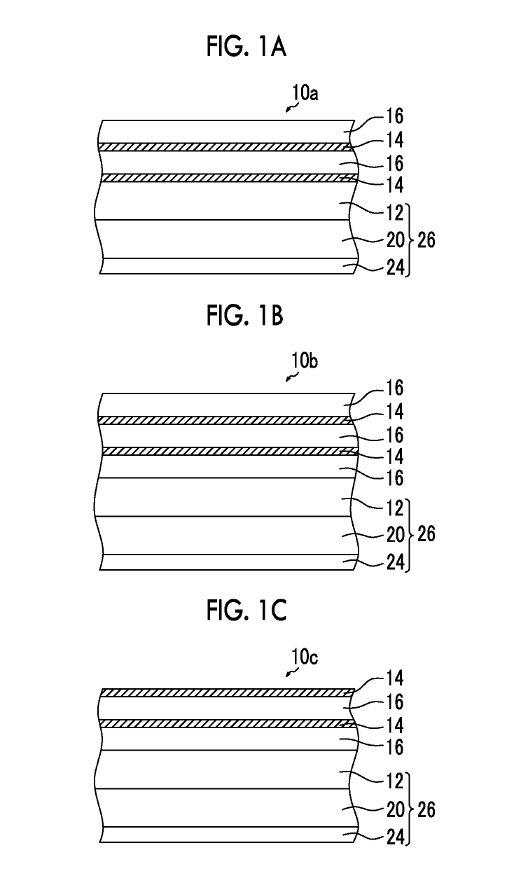

FIG. 1A schematically shows an example in which the functional film of the present invention is used as a gas barrier film.

The functional film of the present invention is not limited to a gas barrier film. That is, the present invention can be used in various known functional films like various optical films such as a filter that transmits light having a specific wavelength and an antireflection film.

In an organic/inorganic laminated-type functional film such as the functional film of the present invention, an inorganic layer mainly exhibits the intended function. Accordingly, the functional film of the present invention should be constituted by selecting an inorganic layer that exhibits the intended function such as a function of transmitting light having a specific wavelength.

According to the present invention, it is possible to obtain a functional film having an inorganic layer without defects such as cracks or fissures by including an adhesive layer or a transport support which will be described later. Furthermore, by peeling off the transport support, the functional film of the present invention can become an adhesive functional film. In addition, by selecting materials having excellent optical characteristics such as a low retardation as the support and the adhesive layer, it is possible to obtain a functional film having excellent optical characteristics.

Accordingly, the present invention is more preferably used in a gas barrier film which is required to have high optical characteristics in many cases, experiences serious deterioration of the performance due to the damage of the inorganic layer, and is used by being laminated on other optical members in many cases.

The gas barrier film according to the functional film of the present invention is the aforementioned organic/inorganic laminated-type gas barrier film in which an inorganic layer 14 and an organic layer 16 are alternately laminated on each other on one surface of a support 12. In FIGS. 1A to 1C, in order to clearly show the constitution, only the inorganic layer 14 is indicated by a hatch pattern. Hereinafter, a surface of the support 12 on which the inorganic layer 14 and the organic layer 16 are formed is also referred to as a “front surface”, and a surface on the opposite side thereof is also referred to as a “rear surface”.

A gas barrier film 10a shown in FIG. 1A has the inorganic layer 14 on the front surface of the support 12, the organic layer 16 on the inorganic layer 14, a second inorganic layer 14 on the organic layer 16, and a second organic layer 16 on the second inorganic layer 14. In this way, the gas barrier film 10a is constituted with a total of four laminated layers including two inorganic layers 14 and two organic layers 16 alternately formed on the support 12.

Furthermore, an adhesive layer 20 is stuck to the rear surface of the support 12, and a transport support 24 is stuck to the adhesive layer 20. A laminate 26 in the present invention is constituted with the support 12, the adhesive layer 20, and the transport support 24.

The gas barrier film (functional film) of the present invention is not limited to the constitution of the gas barrier film 10a shown in FIG. 1A in which a total of four layers including two inorganic layers 14 and two organic layers 16 are alternately laminated in this order on the support 12.

For example, in the gas barrier film 10a shown in FIG. 1A, a third inorganic layer 14 and a third organic layer 16 may be laminated on the second organic layer 16 such that the gas barrier film 10a is constituted with a total of six layers including three inorganic layers 14 and three organic layers 16. Alternatively, another inorganic layer 14 and another organic layer 16 may be alternately laminated such that the gas barrier film 10a is constituted with eight or more layers.

As will be described later, the organic layer 16 functions as an underlayer for appropriately forming the inorganic layer 14. The greater the number of the combination of the organic layer 16 as the underlayer and the inorganic layer 14 laminated, the better the gas barrier properties of the obtained gas barrier film.

Alternatively, just like a gas barrier film 10b schematically shown in FIG. 1B, the gas barrier film of the present invention may have a constitution in which the organic layer 16 is on the front surface of the support 12, the inorganic layer 14 is on the organic layer 16, and another organic layer 16 and another inorganic layer 14 are alternately formed on the inorganic layer 14. That is, in the gas barrier film of the present invention, the number of the inorganic layer 14 and the number of the organic layer 16 may be different from each other.

In addition, as in the gas barrier film 10c schematically shown in FIG. 1C, the inorganic layer 14 may be an uppermost layer.

As described above, the gas barrier film 10a of the present invention has a constitution in which the inorganic layer 14 and the organic layer 16 are alternately laminated on the support 12.

In the gas barrier film 10a of the present invention, as the support 12, various known sheet-like substances utilized as supports of gas barrier films can be used.

Specifically, as the support 12, plastic films composed of various plastics (polymer materials) such as polyethylene terephthalate (PET), polyethylene naphthalate (PEN), polyethylene (PE), polypropylene (PP), polystyrene, polyamide, polyvinyl chloride, polyacrylonitrile, polyimide, polyacrylate, polymethacrylate, polycarbonate (PC), a cycloolefin polymer (COP), a cycloolefin copolymer (COC), triacetylcellulose (TAC), and transparent polyimide are preferably exemplified.

The support 12 may be obtained by forming a layer (film) for obtaining various functions such as a protective layer, an adhesive layer, a light reflection layer, an antireflection layer, a light shielding layer, a planarizing layer, a buffer layer, or a stress relaxation layer on the front surface of the aforementioned plastic films.

In the present invention, as the support 12, a sheet-like substance having a retardation of equal to or less than 300 nm is preferably used. Hereinafter, a sheet-like substance having a retardation of equal to or less than 300 nm is also referred to as a “low-retardation film”.

If the low-retardation film is used as the support 12, by peeling off the transport support 24 from the gas barrier film 10a, a gas barrier film having excellent optical characteristics can be obtained. As a result, for example, when the gas barrier film 10a of the present invention from which the transport support 24 has been peeled off is used in various devices such as an organic EL device, it is possible to prevent the decrease of contrast of light in such devices, the decrease of visibility resulting from the reflection of external light, and the like.

Considering the aforementioned points, the retardation of the support 12 is preferably equal to or less than 200 nm and more preferably equal to or less than 150 nm.

For the same reason, in the present invention, the support 12 preferably has a total light transmittance of equal to or greater than 85%.

As such a low-retardation film, among the aforementioned various plastic films, the plastic films composed of PC, COP, COC, TAC, transparent polyimide, and the like are preferably exemplified.

In the present invention, a thickness of the support 12 is preferably 20 μm to 120 μm.

It is preferable that the support 12 has a thickness of equal to or greater than 20 μm, because then the support is inhibited from being seriously curled due to the formation of the inorganic layer 14 and the organic layer 16; hence the support is easily wound up in the form of a roll; the decrease of yield of the device using the gas barrier film, which is obtained by peeling off the transport support 24 from the gas barrier film 10a, can be prevented; and sufficient mechanical strength can be imparted to the gas barrier film 10a. Examples of the device using the gas barrier film include an organic EL device and the like.

Furthermore, it is preferable that the support 12 has a thickness of equal to or less than 120 μm, because then a gas barrier film 10a having excellent flexibility is obtained; a light-weight gas barrier film 10a is obtained; and the device using the gas barrier film, which is obtained by peeling off the transport support 24 from the gas barrier film 10a, can be thinned.

Considering the aforementioned points, the thickness of the support 12 is more preferably 25 μm to 100 μm.

In the following description, for the sake of convenience, the “gas barrier film which is obtained by peeling off the transport support 24 from the gas barrier film 10a” is also simply referred to as the “gas barrier film 10a from which the transport support 24 has been peeled off”.

A glass transition temperature (Tg) of the support 12 is preferably equal to or higher than 130° C. and more preferably equal to or higher than 140° C.

As described above, the inorganic layer 14 and the organic layer 16 are formed on the front surface of the support 12. Generally, the inorganic layer 14 is formed by a vapor-phase film forming method such as plasma CVD, and the organic layer 16 is formed by a coating method in which a coating material containing an organic compound which will become the organic layer 16 is used for coating and then subjected to drying and curing. That is, in the gas barrier film 10a, the inorganic layer 14 and the organic layer 16 are formed by a method including heating of the support 12.

It is preferable to use a film having Tg of equal to or higher than 130° C. (a film composed of a material having Tg of equal to or higher than 130° C.) as the support 12, because then the support 12 is prevented from being thermally damaged by the heating performed for forming the inorganic layer 14 and the organic layer 16; the durability of the gas barrier film in a heating step in manufacturing the device, which uses the gas barrier film 10a from which the transport support 24 has been peeled off, can be improved; and the durability of the device, which uses the gas barrier film 10a from which the transport support 24 has been peeled off, at a high temperature and high humidity can be improved.

A thermal shrinkage rate of the support 12 is preferably equal to or less than 0.5%.

It is preferable that the thermal shrinkage rate of the support 12 is equal to or less than 0.5%, because then the support 12 can be preferably prevented from being deformed by the heating performed for forming the inorganic layer 14 and the organic layer 16 described above; and the occurrence of warping in the device, which uses the gas barrier film 10a from which the transport support 24 has been peeled off, can be prevented.

As described above, in the gas barrier film 10a of the present invention, the inorganic layer 14 and the organic layer 16 are alternately formed on the support 12.

The inorganic layer 14 is a layer composed of an inorganic compound. In the gas barrier film 10a, the inorganic layer 14 is a layer that mainly exhibits the intended gas barrier properties.

The material forming the inorganic layer 14 is not particularly limited, and various layers composed of inorganic compounds exhibiting gas barrier properties can be used.

Specifically, examples thereof preferably include inorganic compounds like metal oxide such as aluminum oxide, magnesium oxide, tantalum oxide, zirconium oxide, titanium oxide, and indium tin oxide (ITO); metal nitride such as aluminum nitride; metal carbide such as aluminum carbide; oxide of silicon such as silicon oxide, silicon oxynitride, silicon oxycarbide, and silicon oxynitride carbide; nitride of silicon such as silicon nitride and silicon nitride carbide; carbide of silicon such as silicon carbide; hydrides of these; a mixture of two or more kinds of these; hydrogenous compounds of the above compounds; and the like.

Particularly, silicon nitride, silicon oxide, silicon oxynitride, and aluminum oxide are preferably used in the gas barrier film because they have high transparency and can exhibit excellent gas barrier properties. Among these, silicon nitride is particularly preferably used because it has excellent gas barrier properties and high transparency.

In the present invention, a thickness of the inorganic layer 14 is preferably 10 nm to 200 nm.

If the thickness of the inorganic layer 14 is equal to or greater than 10 nm, it is possible to form an inorganic layer 14 which stably exhibits sufficient gas barrier performance. Generally, if the inorganic layer 14 is brittle and excessively thick, cracks, fissures, peeling, and the like are likely to occur. However, if the thickness of the inorganic layer 14 is equal to or less than 200 nm, the occurrence of cracks can be prevented.

Considering the aforementioned points, the thickness of the inorganic layer 14 is preferably 15 nm to 100 nm and particularly preferably 20 nm to 75 nm.

In a case where the gas barrier film 10a has a plurality of inorganic layers 14 as shown in FIG. 1A, the thicknesses of the inorganic layers 14 may be the same as or different from each other.

Likewise, in a case where the gas barrier film 10a has a plurality of inorganic layers 14, the materials forming the inorganic layers 14 may be the same as or different from each other. However, considering the productivity, the production cost, and the like, it is preferable that all of the inorganic layers 14 are formed of the same material.

In the gas barrier film 10a of the present invention, the inorganic layer 14 should be formed by a known inorganic layer forming method appropriate for the material forming the inorganic layer 14.

Specifically, examples of the method include plasma CVD such as CCP-CVD or ICP-CVD; sputtering such as magnetron sputtering or reactive sputtering; and a vapor-phase film forming method (vapor-phase deposition method) such as vacuum vapor deposition; and the like.

In the gas barrier film 10a shown in FIG. 1A, the inorganic layer 14 is formed on the front surface of the support 12.

The inorganic layer 14 formed on the front surface of the support 12 functions not only as a layer exhibiting gas barrier properties but also as a protective layer of the support 12.

As described above, the organic layer 16 is formed by a coating method using a coating material containing an organic compound. The coating material contains an organic solvent such as methyl ethyl ketone (MEK) or methyl isobutyl ketone (MIBK).

Incidentally, the plastic film which will become the support 12 exhibits low resistance with respect to the organic solvent in some cases, and depending on the combination of the plastic film and the organic solvent, the plastic film is dissolved in some cases. Particularly, the aforementioned low-retardation film exhibits low resistance with respect to the organic solvent and is dissolved in many cases. That is, if the organic layer 16 is formed on the front surface of the support 12, depending on the combination of the material forming the support 12 and the organic solvent contained in the coating material, the surface of the support 12 is dissolved in some cases.

If the support 12 is dissolved as described above, problems such as a change in the retardation of the support 12, a decrease in the light transmittance, and an increase in haze occur, and hence the optical characteristics of the gas barrier film greatly deteriorate.

In contrast, as in the gas barrier film 10a shown in FIG. 1A, if the inorganic layer 14 is formed on the front surface of the support 12, and the organic layer 16 and the inorganic layer 14 are alternately laminated thereon, the inorganic layer 14 functions as a layer protecting the support 12 from the organic solvent contained in the coating material for forming the organic layer 16.

As a result, even in a case where the support 12 exhibits low resistance with respect to the organic solvent, it is possible to maintain the optical characteristics of the support 12 by preventing the support 12 from being dissolved by the coating material and to obtain a gas barrier film having excellent optical characteristics.

Herein, when the gas barrier film 10a has a constitution in which the inorganic layer 14 is on the front surface of the support 12 as shown in FIG. 1A, a region like a mixed layer in which the material forming the support 12 is mixed with the material forming the inorganic layer 14 may be placed between the inorganic layer 14 and the support 12.

If the gas barrier film 10a has such a mixed layer, it is possible to improve the strength of the gas barrier film 10a by improving the adhesiveness between the inorganic layer 14 and the support 12 and to prevent the deterioration of the gas barrier properties resulting from the peeling of the inorganic layer 14 from the support 12.

As described above, the inorganic layer 14 is formed by a vapor-phase film forming method such as plasma CVD, and by regulating the film formation conditions, whether or not the mixed layer is to be formed, the thickness of the mixed layer, and the like can be regulated.

For example, when the inorganic layer 14 is formed by plasma CVD, by a method of regulating the intensity of generated plasma by means of regulating the supplied electricity or the like, a method of regulating bias applied at the time of forming the inorganic layer 14, and the like, whether or not the mixed layer is to be formed, the thickness of the mixed layer, and the like can be regulated.

As described above, in the gas barrier film 10c shown in FIG. 1C, the inorganic layer 14 becomes the uppermost layer.

If the inorganic layer 14 is used as the uppermost layer, the discharge of outgas resulting from the organic layer 16 under the inorganic layer 14 can be prevented. Accordingly, the constitution in which the inorganic layer 14 becomes the uppermost layer is preferable in a case where a device such as an organic EL device, which is easily negatively affected by unnecessary gas components, needs to be disposed on, for example, the side of the constitution in which the organic layer 16 and the inorganic layer 14 of the gas barrier film 10a from which the transport support 24 has been peeled off are laminated on each other.

The organic layer 16 is a layer composed of an organic compound. Basically, the organic layer 16 is obtained by cross-linking (polymerizing) an organic compound which will become the organic layer 16.

As described above, the organic layer 16 functions as an underlayer for appropriately forming the inorganic layer 14 exhibiting gas barrier properties. If the gas barrier film has the organic layer 16 as an underlayer, the surface on which the inorganic layer 14 is formed can be planarized and become homogeneous, and thus a state suitable for forming the inorganic layer 14 can be created.

As a result, in the laminated-type gas barrier film in which the organic layer 16 as an underlayer and the inorganic layer 14 are laminated on each other, an appropriate inorganic layer 14 can be formed on the entire surface of the film without gaps, and a gas barrier film having excellent gas barrier properties can be obtained.

The material forming the organic layer 16 in the gas barrier film 10a is not particularly limited, and various known organic compounds (resins/polymer compounds) can be used.

Specifically, examples thereof preferably include thermoplastic resins such as polyester, an acryl resin, a methacryl resin, a methacrylic acid-maleic acid copolymer, polystyrene, a transparent fluorine resin, polyimide, fluorinated polyimide, polyamide, polyamide imide, polyether imide, cellulose acylate, polyurethane, polyether ether ketone, polycarbonate, alicyclic polyolefin, polyarylate, polyether sulfone, polysulfone, fluorene ring-modified polycarbonate, alicyclic modified polycarbonate, fluorene ring-modified polyester, and an acryloyl compound, polysiloxane, and films of other organic silicon compounds. A plurality of these materials may be concurrently used.

Among these, an organic layer 16 constituted with a polymer of a radically polymerizable compound and/or a cationically polymerizable compound having an ether group as a functional group is preferable because such an organic layer is excellent in the glass transition temperature or strength.

Among the above materials, for example, an acryl resin or a methacryl resin having a glass transition temperature of equal to or higher than 120° C. that contains a polymer of a monomer or an oligomer of acrylate and/or methacrylate as a main component is particularly preferable as the organic layer 16, because such a material has excellent strength as described above and is excellent in optical characteristics such as a low refractive index and high transparency.

Particularly, for example, an acryl resin or a methacryl resin such as dipropylene glycol di(meth)acrylate (DPGDA), 1,9-nonanediol di(meth)acrylate (A-NOD-N), 1,6 hexanediol diacrylate (A-HD-N), trimethylolpropane tri(meth)acrylate (TMPTA), (modified) bisphenol A di(meth)acrylate, or dipentaerythritol hexa(meth)acrylate (DPHA) is preferable which contains a polymer of a monomer or the like of acrylate and/or methacrylate having two or more functional groups as a main component. It is also preferable to use a plurality of acryl resins or methacryl resins described above.

If the organic layer 16 is formed of an acryl resin or a methacryl resin, particularly, an acryl resin or a methacryl resin having two or more functional groups, the inorganic layer 14 can be formed on an underlayer having a strong skeleton. Therefore, it is possible to form a denser inorganic layer 14 having high gas barrier properties.

A thickness of the organic layer 16 is preferably 0.5 μm to 5 μm.

If the thickness of the organic layer 16 is equal to or greater than 0.5 μm, the entire surface of the inorganic layer 14 can be reliably covered with the organic layer 16, and the surface of the organic layer 16, that is, the surface on which the inorganic layer 14 is formed can be planarized.

Furthermore, if the thickness of the organic layer 16 is equal to or less than 5 μm, it is possible to preferably prevent the problems resulting from the excessive thickness of the organic layer 16, such as cracking of the organic layer 16 or the curling of the gas barrier film 10a.

Considering the aforementioned points, the thickness of the organic layer 16 is more preferably 1 μm to 3 μm.

In a case where the gas barrier film 10a has a plurality of organic layers 16 as shown in FIG. 1A, the thicknesses of the organic layers 16 may be the same as or different from each other.

Likewise, in a case where the gas barrier film 10a has a plurality of organic layers 16, the materials forming the organic layers 16 may be the same as or different from each other. However, considering the productivity, the production cost, and the like, it is preferable that all of the organic layers 16 are formed of the same material.

In the present invention, basically, the organic layer 16 is formed as an underlayer of the inorganic layer 14. However, the gas barrier film 10a shown in FIG. 1A or the gas barrier film 10b shown in FIG. 1B has the organic layer 16 as the uppermost layer.

The inorganic layer 14 is hard and brittle because it is dense. Therefore, when directly receiving an external impact or the like, the inorganic layer 14 is easily damaged. As described above, in the gas barrier film 10a, the inorganic layer 14 mainly exhibits gas barrier properties. Consequently, when the inorganic layer 14 is damaged, the gas barrier properties deteriorate.

In contrast, if the gas barrier film has the organic layer 16 as the uppermost layer, because the organic layer 16 functions as a protective layer of the inorganic layer 14, the damage of the inorganic layer 14 can be prevented.

In the present invention, basically, the organic layer 16 is formed by a coating method.

That is, at the time of forming the organic layer 16, first, a coating material is prepared by dissolving an organic compound (a monomer, a dimer, a trimer, an oligomer, or the like) which will become the organic layer 16, a cross-linking agent (a polymerization initiator), a silane coupling agent, a surfactant, a thickener, and the like in an organic solvent. Then, the surface on which the organic layer 16 is formed is coated with the coating material and dried. After drying, the organic compound is polymerized by means of ultraviolet irradiation, electron beam irradiation, heating, or the like, thereby forming the organic layer 16.

In the gas barrier film 10a of the present invention, the adhesive layer 20 is stuck to the rear surface of the support 12, and the transport support 24 is stuck to the adhesive layer 20.

As described above, the laminate 26 in the present invention is constituted with the support 12, the adhesive layer 20, and the transport support 24.

As in the examples described in JP2011-149057A or JP2011-167967A, in a case where the support 12 is easily folded and bent and is not easily transported in an appropriate manner when each layer is formed by Roll to Roll (RtoR), the transport support 24 is used for securing a self-supporting property by supporting the support 12 from the rear surface side and for enabling the support 12 to be stably transported without being bent, folded, or wrinkled.

In the gas barrier film 10a of the present invention, the thermal characteristics of the transport support 24 are different from those of the support 12. Furthermore, in the gas barrier film 10a of the present invention, an adhesive force between the adhesive layer 20 and the support 12 is 5 N/25 mm to 50 N/25 mm, and an adhesive force between the adhesive layer 20 and the transport support 24 is 0.01 N/25 mm to 1 N/25 mm. Therefore, in the present invention, even in a case where an expensive support 12 such as a COC film is used, a gas barrier film 10a having an inorganic layer 14 which does not suffer from damages (defects) such as cracks or fissures is realized without increasing the cost.

As described above, in the gas barrier film 10a of the present invention, in order to realize excellent optical characteristics, it is preferable to use a low-retardation film, which is composed of PC, COP, COC, TAC, transparent polyimide, or the like and has a retardation of equal to or less than 300 nm, as the support 12. Furthermore, as described above, it is preferable that the support 12 has a total light transmittance of equal to or greater than 85%.

The transport support 24 is ultimately peeled off and discarded. Therefore, it is preferable to use an inexpensive film such as a PET film as the transport support 24.

However, for example, there is a big difference in Tg between the low-retardation film such as a COC film and the PET film or the like. Furthermore, there is a big difference in a thermal expansion rate/a thermal shrinkage rate therebetween, and thus one of the films thermally expands while the other thermally shrinks. In this way, the low-retardation film and the PET film have different thermal characteristics.

If the inorganic layer 14 or the organic layer 16 is formed by RtoR on the front surface of the support 12 by using the laminate 26 which has the support 12 and the transport support 24 having different thermal characteristics as described above, due to the heat resulting from the plasma at the time of forming the inorganic layer 14 or the heat resulting from drying at the time of forming the organic layer 16, the support 12 and the transport support 24 are deformed in completely different ways and bent due to the stress resulting from the transport or the change of the transport path. Consequently, the support 12 is peeled off from the transport support 24, or the support 12 wrinkles. In addition, due to the peeling of the support 12 from the transport support 24 or wrinkling of the support 12, an appropriate inorganic layer 14 cannot be formed. Furthermore, the previously formed inorganic layer 14 is damaged, and thus the gas barrier properties deteriorate.

If a film composed of the same material as the support 12 is used as the transport support 24, the aforementioned problems do not occur.

However, because a film having high optical characteristics such as a low-retardation film like a COC film is expensive, if the low-retardation film or the like is used as the transport support 24 which is ultimately discarded, the cost of the gas barrier film 10a extremely increases.

In the gas barrier film 10a of the present invention, the adhesive force between the adhesive layer 20 and the support 12 is 5 N/25 mm to 50 N/25 mm, and the adhesive force between the adhesive layer 20 and the transport support 24 is 0.01 N/25 mm to 1 N/25 mm. That is, the adhesive layer 20 is firmly stuck to the support 12 while being stuck to the transport support 24 at an extremely weak force.

Accordingly, when the support 12 and the transport support 24 are deformed in completely different ways due to the heating performed at the time of forming the inorganic layer 14 or the organic layer 16 by RtoR, a process is repeated in which the adhesive layer 20 and the transport support 24 stuck to each other at a weak adhesive force are peeled off from each other and then stuck to each other again by tension.

By the repetition of the peeling and sticking, the deformation of the support 12 and the transport support 24 that occurred in different ways is absorbed. As a result, the peeling of the support 12 from the transport support 24 or the wrinkling of the support 12 that results from the deformation of the supports caused in different ways does not occur, and it is possible to prevent the inappropriate formation (film formation) of the inorganic layer 14 resulting from the wrinkling or the like and to prevent the damage of the previously formed inorganic layer 14.

In the present invention, as the transport support 24, a material having thermal characteristics different from those of the support 12 is used, and the adhesive force between the support 12, the transport support 24, and the adhesive layer 20 is within the aforementioned range. As a result, in manufacturing the gas barrier film by RtoR, the support can be stably transported due to the transport support 24. In addition, when an expensive low-retardation film such as a COC film is used as the support 12 so as to obtain the gas barrier film 10a having excellent optical characteristics, an inexpensive plastic film such as a PET film can be used as the transport support 24 even if the thermal characteristics thereof are different from those of the support 12.

Furthermore, the adhesive layer 20 is firmly stuck to the support 12 while being stuck to the transport support 24 at an extremely weak force. Therefore, even when the transport support 24 is peeled off at the time of use, the adhesive layer 20 remains stuck to the support 12. As a result, by peeling off the transport support 24 at the time of use, the gas barrier film 10a of the present invention can become a gas barrier film having adhesiveness (pressure-sensitive adhesiveness) and can be used for the intended purpose without applying an adhesive thereto or using an adhesive tape.

Particularly, by using the low-retardation film as the support 12 and using an adhesive such as an optical clear adhesive (OCA) having excellent optical characteristics as the adhesive layer 20, the gas barrier film 10a from which the transport support 24 has been peeled off can become a gas barrier film having adhesiveness and excellent optical characteristics. Consequently, the gas barrier film 10a from which the transport support 24 has been peeled off can be preferably used as a gas barrier film used in various devices such as cellular phones, display, and top emission-type organic EL devices.

In the gas barrier film 10a of the present invention, if the adhesive force between the adhesive layer 20 and the support 12 is less than 5 N/25 mm, problems in that a sufficient adhesive force between the adhesive layer 20 and the support 12 is not obtained and the adhesive layer 20 is unnecessarily peeled off from the support 12 or the like occur.

If the adhesive force between the adhesive layer 20 and the support 12 is greater than 50 N/25 mm, problems in that the adhesive layer 20 and the support 12 substantially become a rigid body which makes it difficult to mitigate the deformation of the support 12 and the effect of inhibiting deformation of the support 12 is not sufficiently obtained occur.

Considering the aforementioned points, the adhesive force between the adhesive layer 20 and the support 12 is preferably 8 N/25 mm to 30 N/25 mm.

In the gas barrier film 10a of the present invention, if the adhesive force between the adhesive layer 20 and the transport support 24 is less than 0.01 N/25 mm, problems in that the adhesive layer 20 and the transport support 24 are not stably stuck to each other and the transport support 24 is unnecessarily peeled off from the adhesive layer 20 occur.

If the adhesive force between the adhesive layer 20 and the transport support 24 is greater than 1 N/25 mm, problems in that the transport support 24 cannot be appropriately peeled off at the time of use and the adhesive unevenly remains occur.

Considering the aforementioned points, the adhesive force between the adhesive layer 20 and the transport support 24 is preferably 0.02 N/25 mm to 0.6 N/25 min.

As the method for setting the adhesive force between the adhesive layer 20 and the support 12 to be 5 N/25 mm to 50 N/25 mm and setting the adhesive force between the adhesive layer 20 and the transport support 24 to be 0.01 N/25 mm to 1 N/25 mm in the gas barrier film 10a of the present invention, known methods performed using various adhesives or adhesive tapes can be used. Hereinafter, a case where the adhesive force is 5 N/25 mm to 50 N/25 mm is also referred to as a state of “strong adhesion”, and a case where the adhesive force is 0.01 N/25 mm to 1 N/25 is also referred to as a state of “weak adhesion”.

As one of the aforementioned methods, a method is exemplified in which the adhesive layer 20 which will be in the state of weak adhesion with the support 12 is used, and a release treatment is performed on the surface of the transport support 24 by means of treating the surface with silicon or fluorine such that the adhesive force between the transport support 24 and the adhesive layer 20 is reduced. Alternatively, it is also possible to use a method in which a treatment for improving pressure-sensitive adhesiveness, such as a plasma treatment or a corona treatment, is performed on the support 12, and the same release treatment as described above is performed on the surface of the transport support 24, such that the adhesive layer 20 becomes in the state of strong adhesion with the support 12 and in the state of weak adhesion with the transport support 24.

According to these methods, the adhesive force of the adhesive layer 20 at the time of peeling off the transport support 24 becomes the adhesion strength of the adhesive layer 20. Therefore, by peeling off the transport support 24 from the gas barrier film 10a, a gas barrier film having excellent pressure-sensitive adhesiveness is obtained.

In the present invention, as the adhesive layer 20, depending on the support 12 and the transport support 24, it is possible to use layers composed of various adhesives from which the adhesive force described above is obtained. Among the adhesives, an adhesive such as the aforementioned OCA that can form an adhesive layer 20 having excellent optical characteristics is preferably used.

Specifically, examples of the adhesives include a urethane-based adhesive, an acrylic adhesive, an adhesive obtained by half-curing (semi-curing) an acrylic adhesive, and the like. Herein, as the acrylic adhesive, OCA is preferable.

The half-cured adhesive layer 20 is obtained by, for example, coating the support 12 with an acrylic adhesive as the adhesive layer 20 or sticking, an acrylic adhesive as the adhesive layer 20 to the support 12, sticking the transport support 24 to the adhesive, and then irradiating the adhesive with UV in an amount of about 10% to 50% of the UV irradiation amount necessary for completely curing the adhesive such that the adhesive layer 20 is half-cured. In addition to put the adhesive layer 20 into a half-cured state, it is possible to use an adhesive with a low polymerization degree.

It is preferable that the adhesive layer 20 has a total light transmittance of equal to or greater than 85% and a retardation of equal to or less than 5 nm.

If the adhesive layer 20 has a total light transmittance of equal to or greater than 85% and a retardation of equal to or less than 5 nm, when the transport support 24 is peeled off from the gas barrier film 10a, a gas barrier film having excellent optical characteristics can be obtained.

Considering the aforementioned points, the adhesive layer 20 more preferably has a total light transmittance of equal to or greater than 90%.

A thickness of the adhesive layer 20 is preferably 15 μm to 250 μm.

It is preferable that the adhesive layer 20 has a thickness of equal to or greater than 15 μm, because then the deformation of the support 12 and the transport support 24 that occurs in different ways due to the repetition of peeling and sticking of the adhesive layer 20 and the transport support 24 can be sufficiently absorbed, and the peeling of the support 12 and the transport support 24, wrinkling of the support 12, and the damage of the inorganic layer 14 resulting from the peeling and wrinkling can be more preferably prevented.

Furthermore, it is preferable that the adhesive layer 20 has a thickness of equal to or less than 250 μm, because then the deterioration of thermal conductivity caused by cooling from the rear surface at the time of forming the inorganic layer 14 as will be described later can be prevented; a gas barrier film having better optical characteristics is obtained; and a device using the gas barrier film 10a from which the transport support 24 has been peeled off can be thinned.

Considering the aforementioned points, the thickness of the adhesive layer 20 is more preferably 20 μm to 150 μm.

The adhesive layer 20 should be formed by a known method appropriate for the adhesive or the like to be used. Examples of the method include a method of forming the adhesive layer 20 by coating the support 12 with an adhesive and a method of forming the adhesive layer 20 by using an adhesive tape (pressure-sensitive adhesive tape). In a case where the adhesive layer 20 is formed by coating the support with an adhesive, the adhesive with which the support is coated may be dried and cured (semi-cured).

As the transport support 24, sheet-like substances composed of various materials can be used as long as the thermal characteristics of the materials are different from those of the support 12. Particularly, various plastic films can be used.

In the present invention, a state where the support 12 and the transport support 24 have different thermal characteristics means that one or more out of a case where one of the supports thermally expands while the other thermally shrinks, a case where a difference in the thermal expansion rate or the thermal shrinkage rate between the materials forming the supports is equal to or greater than 0.1%, and a case where a difference in Tg between the materials forming the supports is equal to or higher than 30° C. are satisfied.

If the support 12 and the transport support 24 of the gas barrier film 10a of the present invention have different thermal characteristics as described above, even when an expensive low-retardation film such as a COC film is used as the support 12 as described above, the support can be stably transported by RtoR due to the transport support 24, and an inexpensive PET film can be used as the transport support 24. As a result, an inexpensive gas barrier film 10a in which the inorganic layer 14 is not damaged can be realized.

As described above, the transport support 24 is ultimately peeled off and discarded. Accordingly, it is preferable to use a low-cost material as the transport support 24.

Specifically, examples of the material preferably include a plastic film composed of PET, PP, PE, or the like. Among these, in view of the relationship of Tg which will be described later, a plastic film composed of PET is preferably used.

In the present invention, a thickness of the transport support 24 is preferably 12 μm to 100 μm.

It is preferable that the transport support 24 has a thickness of equal to or greater than 12 μm, because then the effect obtained by providing the transport support 24 can be sufficiently exhibited, and the support 12 (laminate 26) can be stably transported at the time of forming the inorganic layer 14 or the like by RtoR.

Furthermore, it is preferable that the transport support 24 has a thickness of equal to or less than 100 μm, because then the amount of thermal deformation of the transport support 24 at the time of forming the inorganic layer 14 or the like can be reduced; the deterioration of thermal conductivity caused by cooling from the rear surface at the time of forming the inorganic layer 14 as will be described later can be prevented; and a light-weight gas barrier film 10a is obtained.

Considering the aforementioned points, the thickness of the transport support 24 is more preferably 20 μm to 75 μm.

In the present invention, a ratio of the thickness of the transport support 24 to the thickness of the support 12 expressed by “transport support 24/support 12” is preferably 0.1 to 4.

It is preferable that the ratio of the thickness of the transport support 24 to the thickness of the support 12 is within the above range, because then the stress applied to the inorganic layer 14 or the like by the transport support 24 at the time of forming the inorganic layer 14, the organic layer 16, or the like due to the difference in the thermal characteristics between the support 12 and the transport support 24 can be reduced, and higher gas barrier properties can be obtained.

A glass transition temperature (Tg) of the transport support 24 is preferably equal to or higher than 60° C., more preferably equal to or higher than 70° C., and particularly preferably equal to or higher than 80° C.

It is preferable that Tg of the transport support 24 is equal to or higher than 60° C. (it is preferable that the transport support 24 is composed of a material having Tg of equal to or higher than 60° C.) just like the support described above, because then the transport support 24 is prevented from being thermally damaged by heating at the time of forming the inorganic layer 14 and the organic layer 16, and a blocking phenomenon in which the transport support 24 is melted and bonded to the support 12 can be prevented.

A thermal shrinkage rate of the transport support 24 is preferably greater than 0.5% and equal to or less than 2%.

It is preferable that the transport support 24 has a thermal shrinkage rate of greater than 0.5% and equal to or less than 2%, because then the deformation of the transport support 24 at the time of heating is inhibited; the deformation is effectively mitigated by the adhesive layer 20; and the deformation of the support 12 can be inhibited as much as possible. As a result, an appropriate inorganic layer 14 can be formed, the damage of the formed inorganic layer 14 can be prevented, and higher gas barrier properties are obtained.

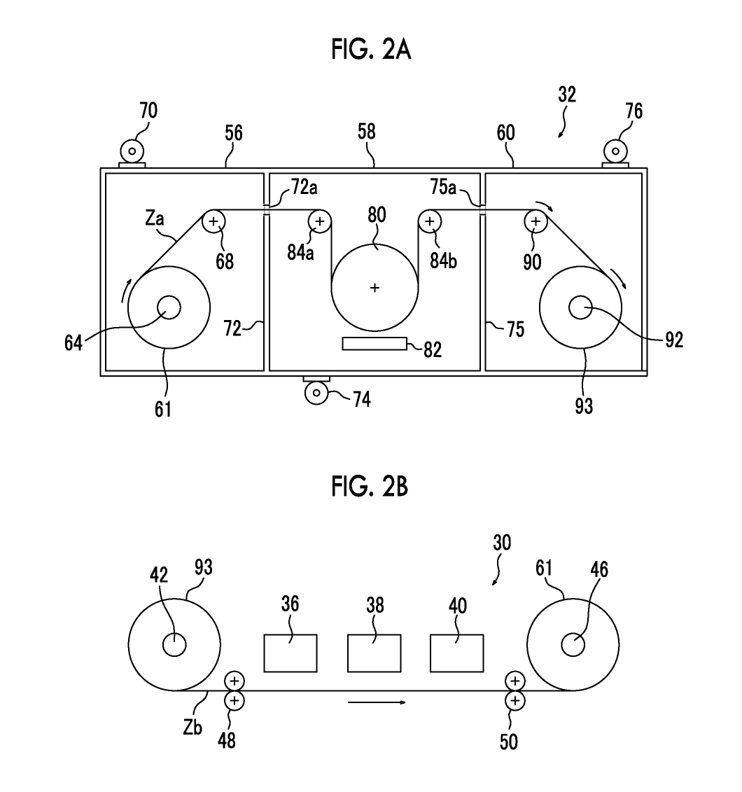

FIGS. 2A and 2B schematically show an example of a manufacturing apparatus for manufacturing the gas barrier film 10a (functional film) of the present invention.

The manufacturing apparatus is constituted with an inorganic film forming device 32 forming the inorganic layer 14 and an organic film forming device 30 forming the organic layer 16.

FIG. 2A shows the inorganic film forming device 32, and FIG. 2B shows the organic film forming device 30.

Both the organic film forming device 30 shown in FIG. 2A and the inorganic film forming device 32 shown in FIG. 2B are devices utilizing Roll to Roll (RtoR) described above, in which a film forming material is unwound from a roll obtained by winding up a long film forming material (a web-like film forming material); each layer (film) is formed while the film forming material is being transported in a longitudinal direction; and the film forming material on which each layer is formed is wound up again in the form of a roll.

RtoR makes it possible to manufacture an excellently efficient gas barrier film 10a (a functional film) with high productivity.

The manufacturing apparatus shown in FIGS. 2A and 2B is an apparatus manufacturing the gas barrier film 10a or the like by sticking the adhesive layer 20 to the rear surface of the long support 12 shown in FIG. 1A, and alternately forming the inorganic layer 14 and the organic layer 16 on the front surface of the support 12 (a surface opposite to the adhesive layer 20) of the laminate 26 which is obtained by sticking the transport support 24 to the adhesive layer 20.

Accordingly, in the inorganic film forming device 32 shown in FIG. 2A, the long laminate 26 and the material which is composed of the laminate 26 and one or more layers formed on the surface of the laminate 26 and includes the organic layer 16 as the surface thereof becomes the film forming material Za.

In the organic film forming device shown in FIG. 2B, the long laminate 26 and the material which is composed of the laminate 26 and one or more layers formed on the surface of the laminate 26 and includes the inorganic layer 14 as the surface thereof becomes the film forming material Zb.

The film forming device 32 is a device which forms the inorganic layer 14 on the surface of the film forming material Za by a vapor-phase deposition method and includes a supply chamber 56, a film forming chamber 58, and a winding-up chamber 60.

The inorganic film forming device 32 may include various members provided in a known device which forms a film by a vapor-phase deposition method while transporting a long film forming material, such as a pair of transport rollers, a guide member restricting the position of the film forming material Za in a width direction, and various sensors, in addition to the members illustrated in the drawing. The width direction is a direction orthogonal to the transport direction.

The supply chamber 56 includes a rotational axis 64, a guide roller 68, and vacuum exhaust means 70.

In the supply chamber 56, a material roll 61 obtained by winding the long film forming material Za, which is the laminate 26 or the laminate 26 on which the organic layer 16 or the like is formed, is loaded on the rotational axis 64.

When the material roll 61 is loaded on the rotational axis 64, the film forming material Za is moved along a predetermined transport path that starts from the supply chamber 56, passes through the film forming chamber 58, and reaches a winding-up axis 92 of the winding-up chamber 60. In the inorganic film forming device 32 using RtoR, the film forming material Za is transported in a longitudinal direction in a state where unwinding of the film forming material Za from the material roll 61 is performed in synchronization with winding-up of the film forming material Za, on which an inorganic layer is formed, around the winding-up axis 92. In this state, in the film forming chamber 58, an inorganic layer is continuously formed on the film forming material Za.

In the supply chamber 56, the rotational axis 64 is rotated clockwise in the drawing by a driving source not shown in the drawing, such that the film forming material Za is unwound from the material roll 61, guided by the guide roller 68 so as to follow a predetermined path, passes through a slit 72a formed on a partition wall 72, and reaches the film forming chamber 58.

In a preferred embodiment of the inorganic film forming device 32 illustrated in the drawing, the vacuum exhaust means 74 is provided in the supply chamber 56, and vacuum exhaust means 76 is provided in the winding-up chamber 60. In the inorganic film forming device 32, by each of the vacuum exhaust means, the pressure of the supply chamber 56 and the winding-up chamber 60 is kept at a predetermined pressure according to the pressure of the film forming chamber 58, which will be described later, during the formation of a film. Therefore, the pressure of the film forming chamber 58, that is, the formation of a film is prevented from being affected by the pressure of the adjacent chamber.

The vacuum exhaust means 70 is not particularly limited, and it is possible to use various known exhaust means used in devices forming a film in a vacuum, such as vacuum pumps like a turbo pump, a mechanical booster pump, a dry pump, and a rotary pump. Regarding this point, the same is true of the other vacuum exhaust means 74 and 76 which will be described later.

The film forming chamber 58 is a unit which forms an inorganic layer on the surface of the film forming material Za (the laminate 26 or the organic layer 16) by a vapor-phase deposition method. The film forming chamber 58 illustrated in the drawing includes a drum 80, film forming means 82, and the vacuum exhaust means 74.

The film forming material Za transported to the film forming chamber 58 is guided by a guide roller 84a so as to follow a predetermined path and is wound around the drum 80 in a predetermined position. In a state of being placed in a predetermined position by the drum 80, the film forming material Za is transported in a longitudinal direction, and the inorganic layer 14 is continuously formed.

The vacuum exhaust means 74 is means for making a vacuum by exhausting gas in the film forming chamber 58 so as to accomplish a degree of vacuum appropriate for forming the inorganic layer 14.

The drum 80 is a cylindrical member that rotates counterclockwise in the drawing around the centerline.

The film forming material Za, which is supplied from the supply chamber 56, guided by the guide roller 84a so as to follow a predetermined path, and wound around on the drum 80 in a predetermined position, is wound around a predetermined region of the peripheral surface of the drum 80 and transported along a predetermined transport path while being supported/guided by the drum 80. In this state, by the film forming means 82, an inorganic layer is formed on the surface of the film forming material Za.

The drum 80 may include temperature control means such that the laminate 26 is cooled during the formation of the inorganic layer 14, for example.

The film forming means 82 is means for forming the inorganic layer 14 on the surface of the film forming material Za by a vapor-phase deposition method.

In the manufacturing process of the present invention, the inorganic layer 14 should be formed by a known vapor-phase deposition method (vapor-phase film forming method) such as the film forming method described in JP2011-149057A or JP2011-167967A. Therefore, the film forming method used by the film forming means 82 is not particularly limited, and it is possible to use all of the known film forming methods such as CVD, plasma CVD, sputtering, vacuum vapor deposition, and ion plating.

Consequently, the film forming means 82 is constituted with various members appropriate for the vapor-phase deposition method to be performed.

For example, if the film forming chamber 58 forms the inorganic layer 14 by an inductively coupled plasma CVD (ICP-CVD) method, the film forming means 82 is constituted with an induction coil for forming an induction magnetic field, gas supply means for supplying reactant gas to a film forming region, and the like.

If the film forming chamber 58 forms the inorganic layer 14 by a capacitively coupled plasma CVD (CCP-CVD) method, the film forming means 82 is constituted with a high-frequency electrode, a shower electrode functioning as reactant gas supply means, and the like that have a hollow shape, have a plurality of small holes in a surface facing a drum 80, and are connected to a reactant gas supply source.

If the film forming chamber 58 forms the inorganic layer 14 by vacuum vapor deposition, the film forming means 82 is constituted with a crucible (evaporation source) filled with a film forming material, a shutter blocking off the crucible, heating means heating the film forming material in the crucible, and the like.

If the film forming chamber 58 forms the inorganic layer 14 by sputtering, the film forming means 82 is constituted with means for holding a target, a high-frequency electrode, gas supply means, and the like.

The conditions for forming the inorganic layer 14 may be appropriately set according to the type of the film forming means 82, an intended film thickness, a film forming rate, and the like.

The film forming material Za, on which the inorganic layer 14 has been formed in a state where the film forming material Za is being supported/transported by the drum 80, is guided by a guide roller 84b so as to follow a predetermined path, passes through a slit 75a formed on a partition wall 75, and is transported to the winding-up chamber 60.

As illustrated in the drawing, the winding-up chamber 60 includes a guide roller 90, the winding-up axis 92, and the vacuum exhaust means 76 described above.

The film forming material Za, which has been transported to the winding-up chamber 60 and on which the film has been formed, is wound around the winding-up axis 92 in the form of a roll. Thereafter, as a material roll 93 obtained by winding up the film forming material Za on which the inorganic layer 14 is formed, the film forming material Za is supplied to the organic film forming device 30. Alternatively, the film forming material Za is supplied for the next step, as a material roll 93 obtained by winding up the gas barrier film 10c or the like.

The organic film forming device 30 shown in FIG. 2B is a device forming the organic layer 16 in a manner in which the long film forming material Zb that is being transported in a longitudinal direction is coated with a coating material which will become the organic layer 16, the coating material is dried, and then an organic compound contained in the coating film is cross-linked and cured by light irradiation.

For example, the organic film forming device 30 illustrated in the drawing includes coating means 36, drying means 38, light irradiation means 40, a rotational axis 42, a winding-up axis 46, a pair of transport rollers 48, and a pair of transport rollers 50.

The organic film forming device 30 may include various members provided in known devices that form films by coating while transporting a long film forming material, such as a pair of transport rollers, a guide member for the film forming material Zb, and various sensors, in addition to the members shown in the drawing.

In the organic film forming device 30, the laminate 26 or the material roll 93 which is obtained by winding up the long film forming material Zb as the laminate 26 on which the inorganic layer 14 or the like is formed, is loaded on the rotational axis 42.

When the material roll 93 is loaded on the rotational axis 42, the film forming material Zb is unwound from the material roll 93, passes through the pair of transport rollers 48, and moves along a predetermined transport path that passes through a portion below the coating means 36, the drying means 38, and the light irradiation means 40 and the pair of transport rollers 50 and reaches the winding-up axis 46.

In the organic film forming device 30 using RtoR, the unwinding of the film forming material Zb from the material roll 93 is performed in synchronization with the winding up of the film forming material Zb, on which the organic layer is formed, around the winding-up axis 46. In this way, in a state where the long film forming material Zb is being transported in a longitudinal direction along a predetermined transport path, the film forming material Zb is coated with a coating material, which will become the organic layer, by the coating means 36, and the coating material is dried by the drying means 38 and cured by the light irradiation means 40, thereby forming an organic layer.

The coating means 36 is means for coating the surface of the film forming material Zb with a coating material which is prepared in advance and forms the organic layer 16.

The coating material is obtained by dissolving an organic compound, which will become the organic layer 16 by being cross-linked and polymerized, in an organic solvent. It is preferable that the coating material contains a silane coupling agent so as to improve the adhesiveness of the organic layer 16. Furthermore, necessary components such as a surfactant (a surface modifier), a cross-linking agent (a polymerization initiator), and thickener may be appropriately added to the coating material.

In the coating means 36, the method for coating the film forming material Zb with the coating material is not particularly limited.

Therefore, the coating with the coating material can be performed by all of the known coating methods such as a die coating method, a dip coating method, an air knife coating method, a curtain coating method, a roller coating method, a wire bar coating method, a gravure coating method, and a slide coating method.

Among these, a die coating method makes it possible to coat the film forming material Zb with the coating material in a noncontact manner, and accordingly, the surface of the film forming material Zb (inorganic layer 14) is not damaged, and the irregularity on the surface of the film forming material Zb can be excellently concealed due to the formation of a bead. For these reasons, the die coating method is preferably used. Herein, the bead refers to a liquid basin.

As described above, the film forming material Zb is then transported to the drying means 38, and the coating material with which the film forming material Zb is coated by the coating means 36 is dried.

The coating material drying method used by the drying means 38 is not particularly limited, and all of the various known drying means can be used as long as the coating material can be dried and can be in a state of being able to be cross-linked before the film forming material Zb reaches the light irradiation means 40. Various know methods can be used, and examples thereof include drying by heating using a heater, drying by heating using hot air, and the like.

The film forming material Zb is then transported to the light irradiation means 40. The light irradiation means 40 irradiates the coating material, with which the film forming material Zb is coated by the coating means 36 and which is dried by the drying means 38, with ultraviolet rays, visible light, or the like so as to cross-link and cure the organic compound contained in the coating material, thereby forming the organic layer 16.

At the time of curing the coating film by the light irradiation means 40, if necessary, the region of the film forming material Zb irradiated with light by the light irradiation means 40 may be in an inert gas atmosphere (oxygen-free atmosphere) by means of nitrogen purging or the like. Furthermore, if necessary, by using a backup roller or the like that comes into contact with the rear surface of the film forming material Zb, the temperature of the film forming material Zb, that is, the temperature of the coating film may be controlled at the time of curing.

In the present invention, the method for cross-linking the organic compound which become the organic layer is not limited to photopolymerization. That is, for cross-linking the organic compound, it is possible to use various methods appropriate for the organic compound which will become the organic layer 16, such as heating polymerization, electron beam polymerization, and plasma polymerization.

In the present invention, as described above, an acrylic resin such as an acryl resin or a methacryl resin is preferably used as the organic layer 16. Therefore, photopolymerization is preferably used.

The film forming material Zb, on which the organic layer 16 is formed in the manner described above, is transported by being pinched between the pair of transport rollers 50, reaches the winding-up axis 46, is wound up again around the winding-up axis 46 in the form of a roll, and becomes the material roll 61 obtained by winding up the film forming material Zb on which the organic layer 16 is formed.

As the material roll 61 obtained by winding up the film forming material Zb on which the organic layer 16 is formed, the material roll 61 is supplied to the inorganic film forming device 32. Alternatively, the material roll 61 is supplied for the next step, as the material roll 61 obtained by winding up the gas barrier film 10a or 10b.

Hereinafter, the operation performed at the time of preparing the gas barrier film 10a, which is shown in FIG. 1A and on which two inorganic layers 14 and two organic layers 16 are formed, in the manufacturing apparatus shown in FIGS. 2A and 2B will be described.

Herein, at the time of preparing the gas barrier film 10b shown in FIG. 1B, the gas barrier film 10c shown in FIG. 1C, or another gas barrier film having a different layer constitution, the inorganic layer 14 and the organic layer 16 may be repeatedly formed in the same manner as described above according to the number of the inorganic layer 14 and the organic layer 16 to be formed or the layer constitution.

First, the adhesive layer 20 is formed on the long support 12, and the transport support 24 is stuck to the adhesive layer 20, thereby preparing a long laminate 26.

The laminate 26 should be formed by, for example, a known method by RtoR in which a long laminate sheet obtained by sticking two sheet-like substances to each other by an adhesive (pressure-sensitive adhesive) is prepared by using a device which is obtained by incorporating means for unwinding a long sheet-like substance from a material roll or means for laminating a long sheet-like substance on another long sheet-like substance such as lamination rollers (a pair of lamination rollers) into the known organic film forming device shown in FIG. 2B.

In a case where it is not necessary to perform the drying and curing of the coating material which will become the adhesive layer 20 in preparing the laminate 26, the drying portion and the curing portion are not required. Furthermore, the adhesive layer 20 may be formed by sticking a long adhesive sheet which will become the adhesive layer 20 to the support 12.

The laminate 26 may be prepared by forming a laminate by sticking the adhesive layer 20 to the transport support 24 and sticking the support 12 to the adhesive layer 20 of the laminate. Alternatively, the laminate 26 may be prepared by forming a laminate by sticking the adhesive layer 20 to the support 12 and sticking the transport support 24 to the adhesive layer 20 of the laminate. In the present invention, it is preferable to use a low-retardation film as the support 12. Therefore, it is preferable to use a method of preparing a laminate obtained by forming the adhesive layer 20 on the transport support 24 and laminating the support 12 on the laminate.

At the time of preparing the laminate 26, a release treatment or the like is performed on the transport support 24 as described above, such that the support 12 and the adhesive layer 20 are in a strong adhesion state, and the transport support 24 and the adhesive layer 20 are in a weak adhesion state.

After the roll obtained by winding up the laminate 26 is prepared, the roll is loaded as the material roll 61 on the rotational axis 64 of the supply chamber 56 of the inorganic film forming device 32.

When the material roll 61 is loaded on the rotational axis 64, the film forming material Zb (laminate 26) is unwound and moves along a predetermined path that starts from the supply chamber 56, passes through the film forming chamber 58, and reaches the winding-up axis 92 of the winding-up chamber 60.

The film forming material Za unwound from the material roll 61 is guided by the guide roller 68 and transported to the film forming chamber 58.

The film forming material Za transported to the film forming chamber 58 is guided by the guide roller 84a, hung on the drum 80, and transported along a predetermined path by being supported by the drum 80. In this state, a first inorganic layer 14 is formed by the film forming means 82 by, for example, CCP-CVD.

The inorganic layer 14 may be formed through a film forming method by a known vapor-phase deposition method appropriate for the inorganic layer 14 to be formed. Therefore, the process gas to be used, the film forming conditions, and the like may be appropriately set/selected according to the inorganic layer 14 to be formed, the film thickness, or the like.

The film forming material Za on which the inorganic layer 14 is formed is guided by the guide roller 84b and transported to the winding-up chamber 60.

The film forming material Za transported to the winding-up chamber 60 is guided to the winding-up axis 92 by the guide roller 90, wound around the winding-up axis 92 in the form of a roll, and becomes the material roll 93.

The material roll 93 obtained by winding up the laminate 26 on which the first inorganic layer 14 is formed is loaded on the rotational axis 42 of the organic film forming device 30.

When the material roll 93 is loaded on the rotational axis 42, the film forming material Zb (laminate 26 on which the first inorganic layer 14 is formed) is unwound from the material roll 93, passes through the pair of transport rollers 48, and moves along a predetermined transport path in which the film forming material Zb passes through the coating means 36, the drying means 38, the light irradiation means 40, and the pair of transport rollers 50 and reaches the rotational axis 46.

The film forming material Zb unwound from the material roll 93 is transported to the coating means 36 by the pair of transport rollers 48, and the surface of the film forming material Zb is coated with the coating material which will become the organic layer 16. As described above, the coating material which will become the organic layer 16 is obtained by dissolving an organic compound such as a monomer appropriate for the organic layer 16 to be formed, a silane coupling agent, a polymerization initiator, and the like in an organic solvent.

The film forming material Zb coated with the coating material which will become the organic layer 16 is then heated by the drying means 38, and as a result, the organic solvent is removed, and the coating material is dried.

Thereafter, the film forming material Zb in which the coating material has been dried is irradiated with ultraviolet rays or the like by a light irradiation portion. As a result, the organic compound is cross-linked and cured, and a first organic layer 16 is formed. If necessary, the organic compound which will become the organic layer 16 may be cured in an inert atmosphere such as a nitrogen atmosphere. Furthermore, at the time of curing the organic compound which will become the organic layer 16, the laminate 26 may be heated.

The film forming material Zb on which the first organic layer 16 is formed is transported by the pair of transport rollers 50, wound up around the winding-up axis 46 in the form of a roll, and supplied again to the inorganic film forming device 32 shown in FIG. 2A as the material roll 61 obtained by winding up the laminate 26 on which one inorganic layer 14 and one organic layer 16 are formed.

In the same manner as described above, the material roll 61 obtained by winding up the laminate 26 on which one inorganic layer 14 and one organic layer 16 are formed is loaded on the rotational axis 64 of the inorganic film forming device 32. From the material roll 61, the laminate 26 on which one inorganic layer 14 and one organic layer 16 are formed is unwound as the film forming material Za and transported to the winding-up axis 92, and a second inorganic layer 14 is formed on the first organic layer 16. As a result, the material roll 93 obtained by winding up the laminate 26 on which the inorganic layer 14, the organic layer 16, and the inorganic layer 14 are formed is prepared and then supplied again to the organic film forming device 30 shown in FIG. 2B.

In the same manner as described above, the material roll 93 obtained by winding up the laminate 26 on which the inorganic layer 14, the organic layer 16, and the inorganic layer 14 are formed is loaded on the rotational axis 42. Then, the laminate 26 on which the inorganic layer 14, the organic layer 16, and the inorganic layer 14 are formed is unwound as the film forming material Zb and transported to the winding-up axis 46, and the coating material which will become the organic layer 16 on the second inorganic layer 14 is dried and cured. As a result, the gas barrier film 10a shown in FIG. 1A in which two inorganic layers 14 and two organic layers 16 are formed is obtained.

The gas barrier film 10a is wound up around the winding-up axis 46 in the form of a roll. The material roll 61 obtained by winding up the gas barrier film 10a is shipped as a product, stored, or supplied for the next step or the like.

As described above, the gas barrier film of the present invention has the transport support 24. Therefore, even if the support 12 is thin and easily folded and bent, the film forming materials Za and Zb can be stably transported at the time of forming the inorganic layer 14 or the organic layer 16 by RtoR.

Furthermore, as described above, in the laminate 26, the adhesive force between the adhesive layer 20 and the support 12 is 5 N/25 mm to 50 N/25 mm, and the adhesive force between the adhesive layer 20 and the transport support 24 is 0.01 N/25 mm to 1 N/25 mm. Therefore, even if the laminate 26 is heated due to the formation of the inorganic layer 14 or heated for drying the coating material at the time of forming the organic layer 16, and the support 12 and the transport support 24 are deformed in different ways, because the adhesive layer 20 and the transport support 24 are repeatedly peeled off from each other and stuck to each other, the deformation thereof occurring in different ways is absorbed. As a result, the peeling of the support 12 from the transport support 24, the wrinkling of the support 12, and the like do not occur, and thus the damage of the inorganic layer 14 resulting from the peeling, wrinkling, and the like can be prevented.

Hitherto, the functional film of the present invention and the process for manufacturing a functional film of the present invention have been specifically described. However, the present invention is not limited to the examples described above. It goes without saying that the present invention can be modified or changed in various ways within a scope that does not depart from the gist of the present invention.

### EXAMPLES

Hereinafter, the present invention will be more specifically described based on specific examples.

### Example 1

As the support 12, a long COC film (F1 film manufactured by GUNZE LIMITED) having a width of 1,000 mm and a thickness of 50 μm was prepared. A thermal shrinkage of the support 12 is 0.05% in an MD direction and 0.02% in a TD direction.

As the transport support 24, a long PET film (Lumirror manufactured by TORAY INDUSTRIES, INC.) having a width of 1,000 mm and a thickness of 50 μm was prepared. A thermal shrinkage of the PET film is 1% in an MD direction and 0.5% in a TD direction. Furthermore, the surface of the transport support 24 was subjected to a release treatment using a fluorine coating.

The release-treated surface of the transport support 24 was coated with an acrylic OCA (PDS1 manufactured by PANAC Corporation) as the adhesive layer 20. Herein, the transport support 24 was coated with the acrylic OCA such that the thickness of the adhesive layer 20 after curing became 25 μm.

Thereafter, the support 12 (COC film) was stuck to the adhesive layer 20, thereby preparing the laminate 26 composed of the support 12, the adhesive layer 20, and the transport support 24.

The treatment described above was performed by using a known apparatus by RtoR including means for coating the transport support with an adhesive and means for laminating long sheet-like substances.

In the laminate 26, the adhesive forces between the support 12 and the adhesive layer 20 and between the transport support 24 and the adhesive layer 20 were measured by a peeling test method specified in JIS Z 0237. As a result, it was confirmed that the adhesive force between the support 12 and the adhesive layer 20 was 20 N/25 mm and the adhesive force between the transport support 24 and the adhesive layer 20 was 0.5 N/25 mm.

The material roll 61 obtained by winding up the laminate 26 was loaded on the rotational axis 64 of the inorganic film forming device 32 shown in FIG. 2A, and the inorganic layer 14 having a thickness of 25 nm was formed on a front surface (a surface on the side opposite to the adhesive layer 20) of the support 12. That is, the laminate 26 is the film forming material Za.

As the film forming gas, silane gas (SiH₄), ammonia gas (NH₃), nitrogen gas (N₂), and hydrogen gas (H₂) were used. The amount of each gas supplied was 100 sccm for the silane gas, 200 sccm for the ammonia gas, 500 sccm for the nitrogen gas, and 500 sccm for the hydrogen gas. The film forming pressure was 50 Pa.

To a shower electrode for forming a film, 3,000 W of plasma excitation power was supplied from a high-frequency power source at a frequency of 13.5 MHz. Furthermore, to the drum 80, 500 W of bias power was supplied from a bias power source. During the formation of a film, the temperature of the drum 80 was controlled to become −20° C.

After the formation of the inorganic layer 14 ended, the supply chamber 56, the film forming chamber 58, and the winding-up chamber 60 were opened to the atmosphere by introducing clean and dry air into the chambers.

Thereafter, the material roll 93 obtained by winding up the laminate 26 on which the inorganic layer 14 was formed was taken out of the winding-up chamber 60.

The material roll 93 obtained by winding up the laminate 26 on which the inorganic layer 14 was formed was loaded on the rotational axis 42 of the organic film forming device 30 shown in FIG. 2B, and the organic layer 16 having a thickness of 3 μm was formed on the surface of the inorganic layer 14. That is, the laminate 26 on which the inorganic layer 14 is formed is the film forming material Zb.

A coating material for forming the organic layer 16 was prepared by adding TMPTA (manufactured by Daicel-Cytec Company Ltd.), a photopolymerization initiator (Irg 189 manufactured by Ciba Specialty Chemicals, Inc.), a silane coupling agent (KBM 5103 manufactured by Shin-Etsu Silicones), and a thickener (ACRIT 8BR500 manufactured by TAISEI FINE CHEMICAL CO., LTD.) to MEK. That is, the organic layer 16 is a layer obtained by polymerizing TMPTA.

The amount of the photopolymerization initiator added was 2% by mass in terms of concentration excluding the organic solvent; the amount of the silane coupling agent added was 10% by mass in terms of concentration excluding the organic solvent; and the amount of the thickener added was 1% by mass in terms of concentration excluding the organic solvent. That is, in the coating material, the amount of the organic compound in the solid content is 87% by mass.

The concentration of the solid content in the coating material, which was obtained by diluting the components formulated at the above ratio with MEK, was 15% by mass. That is, in the coating material, the amount of MEK is 85% by mass.

As the coating means 36, a die coater was used. As the drying means 38, a device blowing out dry air from a nozzle was used, and drying was performed at 80° C. Furthermore, by irradiating the coating material with ultraviolet rays from the light irradiation means 40, TMPTA was polymerized. Herein, by setting the irradiation amount of the ultraviolet rays to be 500 mJ/cm² as a cumulative irradiation amount, the coating material was cured by the ultraviolet rays in a state where the support 12 was being heated to 80° C. from the rear surface side thereof.

Thereafter, the material roll 61 obtained by winding up the laminate 26 on which the organic layer 16 was formed on the inorganic layer 14 was loaded again on the inorganic film forming device 32 shown in FIG. 2A, and an inorganic layer 14 having a thickness of 50 nm was formed in the same manner as described above, thereby preparing the material roll 93 obtained by winding up the laminate 26 on which the inorganic layer 14, the organic layer 16, and the inorganic layer 14 were formed.

The material roll 93 was loaded again on the organic film forming device 30 shown in FIG. 2B, and an organic layer 16 having a thickness of 0.5 μm was formed in the same manner as described above, thereby preparing the gas barrier film 10a shown in FIG. 1A obtained by forming the inorganic layer 14, the organic layer 16, the inorganic layer 14, and the organic layer 16 on the surface of the laminate 26 composed of the support 12, the adhesive layer 20, and the transport support 24.

### Examples 2 and 3

The gas barrier film 10a shown in FIG. 1A was prepared in the same manner as in Example 1, except that the thickness of the support 12 was set to be 25 μm (Example 2), and the thickness of the support 12 was set to be 100 μm (Example 3).

The support 12 is a COC film.

### Examples 4 to 7

The gas barrier film 10a shown in FIG. 1A was prepared in the same manner as in Example 1, except that the thickness of the transport support 24 was set to be 12 μm (Example 4); the thickness of the transport support 24 was set to be 75 μm (Example 5); the thicknesses of the support 12 and the transport support 24 were set to be 25 μm and 12 μm respectively (Example 6); and the thicknesses of the support 12 and the transport support 24 were set to be 25 μm and 100 μm respectively (Example 7).

The transport support 24 is a PET film, and the support 12 is a COC film.

### Examples 8 to 11

The gas barrier film 10a shown in FIG. 1A was prepared in the same manner as in Example 1, except that the thickness of the adhesive layer 20 was set to be 5 μm (Example 8); the thickness of the adhesive layer 20 was set to be 10 μm (Example 9); the thickness of the adhesive layer 20 was set to be 100 μm (Example 10); and the thickness of the adhesive layer 20 was set to be 200 μm (Example 11).

The adhesive layer 20 is an acrylic OCA.

### Examples 12 and 13

The gas barrier film 10a shown in FIG. 1A was prepared in the same manner as in Example 1, except that the rear surface of the support 12 was coated with fluorine (Example 12), and the rear surface of the support 12 was subjected to a corona treatment (Example 13).

The adhesive force between the support 12 and the adhesive layer 20 was measured in the same manner as in Example 1. As a result, it was confirmed that the adhesive force was 5 N/25 mm in Example 12 and 30 N/25 mm in Example 13.

The support 12 is a COC film, the adhesive layer 20 is an acrylic OCA, and the rear surface of the support 12 refers to a surface on which the adhesive layer 20 is formed.

### Examples 14 to 16

The gas barrier film 10a shown in FIG. 1A was prepared in the same manner as in Example 1, except that the support 12 was changed to a PC film (T138 manufactured by TEIJIN LIMITED) having a thickness of 50 μm (Example 14); the support 12 was changed to a PC film having a thickness of 25 μm (Example 15); and the support 12 was changed to a PC film having a thickness of 100 μm (Example 16).

A thermal shrinkage of the support 12 is 0.3% in both the MD direction and the TD direction.

Furthermore, the adhesive force between the support 12 and the adhesive layer 20 was measured in the same manner as in Example 1. As a result, it was confirmed that the adhesive force was 20 N/25 mm in all of Examples 14 to 16.

The adhesive layer 20 is an acrylic OCA.

### Examples 17 and 18

The gas barrier film 10a shown in FIG. 1A was prepared in the same manner as in Example 1, except that the surface of the transport support 24 was subjected to a release treatment by using a fluorine coating different from the fluorine coating used in Example 1 (Example 17), and the surface of the transport support 24 was subjected to a release treatment by using a fluorine coating different from the fluorine coating used in Example 1 (Example 18). The fluorine coating in Example 18 is also different from the fluorine coating in Example 17.

The adhesive force between the transport support 24 and the adhesive layer 20 was measured in the same manner as in Example 1. As a result, it was confirmed that the adhesive force is 0.01 N/25 mm in Example 17 and 1 N/25 mm in Example 18.

The transport support 24 is a PET film, and the adhesive layer 20 is an acrylic OCA.

### Example 19

The gas barrier film 10a shown in FIG. 1A was prepared in the same manner as in Example 1, except that a two-component curable-type urethane adhesive (Takenate manufactured by Mitsui Chemicals, Inc.) was used as the adhesive layer 20.

The adhesive forces between the support 12 and the adhesive layer 20 and between the transport support 24 and the adhesive layer 20 were measured in the same manner as in Example 1. As a result, it was confirmed that the adhesion force between the support 12 and the adhesive layer 20 was 20 N/25 mm, and the adhesive force between the transport support 24 and the adhesive layer 20 was 0.5 N/25 mm.

The support 12 is a COC film, and the transport support 24 is a PET film.

### Comparative Example 1

The gas barrier film 10a shown in FIG. 1A was prepared in the same manner as in Example 1, except that the surface of the transport support 24 was not subjected to a release treatment.

The adhesive forces between the support 12 and the adhesive layer 20 and between the transport support 24 and the adhesive layer 20 were measured in the same manner as in Example 1. As a result, it was confirmed that the adhesive forces between the support 12 and the adhesive layer 20 and between the transport support 24 and the adhesive layer 20 were both 20 N/25 mm.

The support 12 is a COC film, the transport support 24 is a PET film, and the adhesive layer 20 is an acrylic OCA.

### Comparative Example 2

The gas barrier film 10a shown in FIG. 1A was prepared in the same manner as in Example 1, except that the surface of the transport support 24 was not subjected to a release treatment, and the surface of the support 12 to which the adhesive layer 20 was stuck was subjected to the same release treatment as in Example 1.

The adhesive forces between the support 12 and the adhesive layer 20 and between the transport support 24 and the adhesive layer 20 were measured in the same manner as in Example 1. As a result, it was confirmed that the adhesive force between the support 12 and the adhesive layer 20 was 0.5 N/25 mm, and the adhesive force between the transport support 24 and the adhesive layer 20 was 20 N/25 mm.

The support 12 is a COC film, the transport support 24 is a PET film, and the adhesive layer 20 is an acrylic OCA.

### Comparative Example 3

The gas barrier film 10a shown in FIG. 1A was prepared in the same manner as in Example 1, except that the rear surface of the support 12 was subjected to a corona treatment. Herein, the corona treatment was performed under the conditions different from the conditions of Example 13.

The adhesive force between the support 12 and the adhesive layer 20 was measured in the same manner as in Example 1. As a result, it was confirmed that the adhesive force between the support 12 and the adhesive layer 20 was 55 N/25 mm.

The support 12 is a COC film, the adhesive layer 20 is an acrylic OCA, and the rear surface of the support 12 is a surface on which the adhesive layer 20 is formed.

### COMPARATIVE EXAMPLE

The gas barrier film 10a shown in FIG. 1A was prepared in the same manner as in Example 1, except that the surface of the transport support 24 was subjected to a release treatment by using a fluorine coating different from the fluorine coating used in Example 1. Herein, the fluorine coating is also different from the fluorine coating used in Examples 17 and 18.

The adhesive force between the transport support 24 and the adhesive layer 20 was measured in the same manner as in Example 1. As a result, it was confirmed that the adhesive force was 0.005 N/25 mm.

The transport support 24 is a PET film, and the adhesive layer 20 is an acrylic OCA.

### Comparative Example 5

The gas barrier film 10a shown in FIG. 1A was prepared in the same manner as in Example 1, except that the rear surface of the support 12 was subjected to a release treatment by using the same fluorine coating as used for transport support 24.

The adhesive force between the support 12 and the adhesive layer 20 was measured in the same manner as in Example 1. As a result, it was confirmed that the adhesive force was 0.5 N/25 mm.

The support 12 is a COC film, the transport support 24 is a PET film, and the adhesive layer 20 is an acrylic OCA. The rear surface of the support 12 is a surface on which the adhesive layer 20 is formed.

[Evaluation]

From each of the gas barrier films 10a of Examples 1 to 19 and Comparative examples 1 and 2 prepared as above, the transport support 24 was peeled off. Thereafter, a λ/4 film (PC film manufactured by TEIJIN LIMITED) for preventing reflection of external light was stuck to the adhesive layer 20, and the gas barrier properties and the total light transmittance were evaluated.

<Gas Barrier Properties>

By a calcium corrosion method (method descried in JP2005-283561A), a water vapor transmission rate [g/(m²·day)] of the gas barrier film to which the λ/4 film was stuck was measured. Herein, a thermo-hygrostat treatment was performed under conditions of a temperature of 40° C. and a humidity of 90% RH. The gas barrier properties were evaluated based on the following criteria.

AAA: a water vapor transmission rate of less than 7×10⁻⁶ [g/(m²·day)]

AA: a water vapor transmission rate of equal to or greater than 7×10⁻⁶ [g/(m²·day)] and less than 9×10⁻⁶ [g/(m²·day)]

A: a water vapor transmission rate of equal to or greater than 9×10⁻⁶ [g/(m²·day)] and less than 2.5×10⁻⁵ [g/(m²·day)]

B: a water vapor transmission rate of equal to or greater than 2.5×10⁻⁵ [g/(m²·day)] and less than 4.5×10⁻⁵ [g/(m²·day)]

C: a water vapor transmission rate of equal to or greater than 4.5×10⁻⁵ [g/(m²·day)] and less than 9×10⁻⁵ [g/(m²·day)]

D: a water vapor transmission rate of equal to or greater than 9×10⁻⁵ [g/(m²·day)] and less than 2×10⁻⁴ [g/(m²·day)]

E: a water vapor transmission rate of equal to or greater than 2×10⁻⁴ [g/(m²·day)]

<Total Light Transmittance>

By using NDH 5000 manufactured by NIPPON DENSHOKU INDUSTRIES Co., LTD, a total light transmittance of the gas barrier film to which the λ/4 film was stuck was measured based on JIS K 7361.

The results are shown in the following table.

TABLE 1

| | Support | | | | Adhesive layer | | | | | | |
|---|---|---|---|---|---|---|---|---|---|---|---|
| | | Thick- | Transport | | | | Adhesive | | Gas barrier properties | | Total light |
| | | ness | Thickness | Thickness | | Thickness | force [N/25 mm] | | Transmission rate | | transmittance |
| | Material | [μm] | [μm] | ratio | Material | [μm] | Support | Transport | [g/(m² · day)] | Evaluation | [%] |
| Example 1 | COC | 50 | 50 | 1 | OCA | 25 | 20 | 0.5 | 2 × 10⁻⁵ | A | 90 |
| Example 2 | COC | 25 | 50 | 2 | OCA | 25 | 20 | 0.5 | 4 × 10⁻⁵ | B | 90 |
| Example 3 | COC | 100 | 50 | 0.5 | OCA | 25 | 20 | 0.5 | 8.9 × 10⁻⁶ | AA | 90 |
| Example 4 | COC | 50 | 12 | 0.24 | OCA | 25 | 20 | 0.5 | 6 × 10⁻⁶ | AAA | 90 |
| Example 5 | COC | 50 | 75 | 1.5 | OCA | 25 | 20 | 0.5 | 3 × 10⁻⁵ | B | 90 |
| Example 6 | COC | 25 | 12 | 0.48 | OCA | 25 | 20 | 0.5 | 8.5 × 10⁻⁶ | AA | 90 |
| Example 7 | COC | 25 | 100 | 4 | OCA | 25 | 20 | 0.5 | 6 × 10⁻⁵ | C | 90 |
| Example 8 | COC | 50 | 50 | 1 | OCA | 5 | 20 | 0.5 | 8 × 10⁻⁵ | C | 90 |
| Example 9 | COC | 50 | 50 | 1 | OCA | 10 | 20 | 0.5 | 2.2 × 10⁻⁵ | A | 90 |
| Example 10 | COC | 50 | 50 | 1 | OCA | 100 | 20 | 0.5 | 3 × 10⁻⁵ | B | 90 |
| Example 11 | COC | 50 | 50 | 1 | OCA | 200 | 20 | 0.5 | 5.5 × 10⁻⁵ | C | 90 |
| Example 12 | COC | 50 | 50 | 1 | OCA | 25 | 5 | 0.5 | 6 × 10⁻⁵ | C | 90 |
| Example 13 | COC | 50 | 50 | 1 | OCA | 25 | 30 | 0.5 | 8 × 10⁻⁶ | AA | 90 |
| Example 14 | PC | 50 | 50 | 1 | OCA | 25 | 20 | 0.5 | 4 × 10⁻⁵ | B | 90 |
| Example 15 | PC | 25 | 50 | 2 | OCA | 25 | 20 | 0.5 | 5 × 10⁻⁵ | C | 90 |
| Example 16 | PC | 100 | 50 | 0.5 | OCA | 25 | 20 | 0.5 | 2.3 × 10⁻⁵ | A | 90 |
| Example 17 | COC | 50 | 50 | 1 | OCA | 25 | 20 | 0.01 | 2.3 × 10⁻⁵ | A | 90 |
| Example 18 | COC | 50 | 50 | 1 | OCA | 25 | 20 | 1 | 2.2 × 10⁻⁵ | A | 90 |
| Example 19 | COC | 50 | 50 | 1 | Two- | 25 | 20 | 0.5 | 2.1 × 10⁻⁵ | A | 80 |
| | | | | | component | | | | | | |
| | | | | | type | | | | | | |
| Comparative | COC | 50 | 50 | 1 | OCA | 25 | 20 | 20 | 1.5 × 10⁻⁴ | D | 90 |
| example 1 | | | | | | | | | | | |
| Comparative | COC | 50 | 50 | 1 | OCA | 25 | 0.5 | 20 | 7 × 10⁻⁴ | E | 90 |
| example 2 | | | | | | | | | | | |
| Comparative | COC | 50 | 50 | 1 | OCA | 25 | 55 | 0.5 | 1.7 × 10⁻⁴ | D | 90 |
| example 3 | | | | | | | | | | | |
| Comparative | COC | 50 | 50 | 1 | OCA | 25 | 20 | 0.005 | 6.5 × 10⁻⁴ | E | 90 |
| example 4 | | | | | | | | | | | |
| Comparative | COC | 50 | 50 | 1 | OCA | 25 | 0.5 | 0.5 | 6.5 × 10⁻⁴ | E | 90 |
| example 5 | | | | | | | | | | | |

In the table, “transport” indicates a “transport support”, and “two-component type” indicates a “two-component curable-type urethane adhesive”.
A thermal shrinkage rate of the support (COC) is MD/TD: 0.05/0.02 in all cases.
A thermal shrinkage rate of the support (PC) is MD/TD: 0.3/0.3 in all cases.
In all cases, the transport support (transport) is formed of PET, and a thermal shrinkage rate thereof is MD/TD: 1/0.5.

As shown in the above table, all of the gas barrier films of the present invention have excellent gas barrier properties in which the water vapor transmission rate is less than 9×10⁻⁵ [g/(m²·day)]. Furthermore, in a case where a COC film or a PC film having excellent optical characteristics was used as the support 12, and an OCA is used as the adhesive layer 20, the gas barrier films have excellent optical characteristics in which the total light transmittance is 90%. In Example 17, because the two-component curable-type urethane adhesive is used as the adhesive layer 20, the total light transmittance is lower than that of other gas barrier films.

In contrast, in Comparative example 1 in which the adhesive forces between the support 12 and the adhesive layer 20 and between the transport support 24 and the adhesive layer 20 are both 20 N/25 mm, peeling occurs between the adhesive layer 20 and the support 12 at the time of forming the inorganic layer 14 and the organic layer 16. It is considered that for this reason, the inorganic layer 14 is damaged, and the gas barrier properties deteriorate.

In Comparative example 2 in which the adhesive force between the support 12 and the adhesive layer 20 is 0.5 N/25 mm and the adhesive force between the transport support 24 and the adhesive layer 20 is 20 N/25 mm, the adhesion force between the transport support 24 and the adhesive layer 20 is strong. Consequently, the deformation of the transport support 24 having a high thermal shrinkage rate is transmitted to the support 12, and thus the support 12 is wrinkled. It is considered that due to the wrinkling of the support 12, cracks, fissures, and the like occur in the inorganic layer 14, and the gas barrier properties deteriorate.

In Comparative example 3 in which the adhesive force between the support 12 and the adhesive layer 20 is 55 N/25 mm and the adhesive force between the transport support 24 and the adhesive layer 20 is 0.5 N/25 mm, because the adhesive force between the support 12 and the adhesive layer 20 is too strong, the support 12 and the adhesive layer 20 become too rigid. It is considered that for this reason, the deformation of the support 12 cannot be inhibited, cracks, fissures, and the like occur in the inorganic layer 14 due to the deformation of the support 12, and the gas barrier properties deteriorate.

In Comparative example 4 in which the adhesive force between the support 12 and the adhesive layer 20 is 20 N/25 mm and the adhesive force between the transport support 24 and the adhesive layer 20 is 0.005 N/25 mm, the transport support 24 is peeled off, and thus the transport becomes unstable at the time of forming the inorganic layer 14 or the like. It is considered that for this reason, cracks, fissures, and the like occur in the inorganic layer 14, and the gas barrier properties deteriorate.

In Comparative example 5 in which the adhesive forces between the support 12 and the adhesive layer 20 and between the transport support 24 and the adhesive layer 20 are both 0.5 N/25 mm, the adhesive force between the support 12 and the adhesive layer 20 is too weak, and thus the support 12 is deformed and wrinkled. It is considered that due to the wrinkling of the support 12, cracks, fissures, and the like occur in the inorganic layer 14, and the gas barrier properties deteriorate.

The above results clearly show the effects of the present invention.

The present invention can be preferably used as a protective film or the like of organic EL devices.

### EXPLANATION OF REFERENCES

10a, 10b, 10c: gas barrier film
12: support
14: inorganic layer
16: organic layer
20: adhesive layer
24: transport support
26: laminate
30: organic film forming device
32: inorganic film forming device
36: coating means
38: drying means
40: light irradiation means
42, 64: rotational axis
46, 92: winding-up axis
48, 50: a pair of transport rollers
56: supply chamber
58: film forming chamber
60: winding-up chamber
61, 93: material roll
68, 84a, 84b, 90: guide roller
70, 74, 76: vacuum exhaust means
72, 75: partition wall
80: drum

What is claimed is:

1. A functional film comprising:
a support;
an organic layer and an inorganic layer which are alternately formed on the support;
an adhesive layer which is stuck to a surface of the support opposite to a surface of the support on which the organic layer and the inorganic layer are formed; and
a transport support which is stuck to the adhesive layer and has thermal characteristics different from thermal characteristics of the support,
wherein an adhesive force between the adhesive layer and the support is 5 N/25 mm to 50 N/25 mm, and an adhesive force between the adhesive layer and the transport support is 0.01 N/25 mm to 1 N/25 mm.

2. The functional film according to claim 1,
wherein the adhesive layer has a thickness of 15 μm to 250 μm.

3. The functional film according to claim 1,
wherein the adhesive layer has a total light transmittance of equal to or greater than 85% and a retardation of equal to or less than 5 nm.

4. The functional film according to claim 1,
wherein the support has a retardation of equal to or less than 300 nm.

5. The functional film according to claim 1,
wherein the support has a glass transition temperature of equal to or higher than 130° C., a thermal shrinkage rate of equal to or less than 0.5%, and a thickness of 20 μm to 120 μm, and
the transport support has a glass transition temperature of equal to or higher than 60° C., a thermal shrinkage rate of greater than 0.5% and equal to or less than 2%, and a thickness of 12 μm to 100 μm.

6. A process for manufacturing a functional film, comprising:
preparing a long laminate by sticking an adhesive layer to a support at an adhesive force of 5 N/25 mm to 50 N/25 mm and sticking a transport support, which has thermal characteristics different from thermal characteristics of the support, to a surface of the adhesive layer opposite to the support at an adhesive force of 0.01 N/25 mm to 1 N/25 mm; and
alternately forming an organic layer by a coating method and an inorganic layer by a vapor-phase film forming method on a surface of the support opposite to the adhesive layer while transporting the laminate in a longitudinal direction.

7. The process for manufacturing a functional film according to claim 6,
wherein the adhesive layer has a thickness of 15 μm to 250 μm.

8. The process for manufacturing a functional film according to claim 6,
wherein the adhesive layer has a total light transmittance of equal to or greater than 85% and a retardation of equal to or less than 5 nm.

9. The process for manufacturing a functional film according to claim 6,
wherein the support has a retardation of equal to or less than 300 nm.

10. The process for manufacturing a functional film according to claim 6,
wherein the support has a glass transition temperature of equal to or higher than 130° C., a thermal shrinkage rate of equal to or less than 0.5%, and a thickness of 20 μm to 120 μm, and
the transport support has a glass transition temperature of equal to or higher than 60° C., a thermal shrinkage rate of greater than 0.5% and equal to or less than 2%, and a thickness of 12 μm to 100 μm.
